(19) United States
(12) Patent Application Publication
(10) Pub. No.: US 2026/0331954 A1
(43) Pub. Date: Oct. 22, 2026

(54) CONTACTLESS ENERGY TRANSMISSION DEVICE, KIT-OF-PARTS FOR MANUFACTURING A CONTACTLESS ENERGY TRANSMISSION DEVICE, ROTOR OF AN ELECTRIC MACHINE, ELECTRIC MACHINE, AND METHOD FOR ASSEMBLING A ROTOR

(71) Applicant: Schaeffler Technologies AG & Co. KG, Herzogenaurach (DE)

(72) Inventors: Martin Kunkemoeller, Sasbach (DE); Thomas Hurle, Bühlertal (DE); Christian Oehler, Tutzing (DE); Christian Hartmann, Emskirchen (DE); Jan Michel Wassermann, München (DE); Richard Bernauer, Weilheim (DE); Kevin Klumpp, Ellenberg (DE)

(73) Assignee: Schaeffler Technologies AG & Co. KG, Herzogenaurach (DE)

(21) Appl. No.: 19/113,986

(22) PCT Filed: Sep. 13, 2023
(86) PCT No.: PCT/DE2023/100678

§ 371 Date: Mar. 21, 2025

(30) Foreign Application Priority Data
Sep. 23, 2022 (DE) 10 2022 124 447.4

(51) Int. Cl. H02J 50/10; H01F 27/28; H02K 7/00; H02K 11/00

(52) U.S. Cl. CPC H02J 50/10; H01F 27/28; H02K 7/003; H02K 11/0094

(57) ABSTRACT

A contactless energy transmission device for a rotor of an electric machine, such as a separately excited synchronous machine inside a drive train of a motor vehicle is provided. The energy transmission device includes: a hollow shaft which can be coupled to the rotor of the electric machine in a torque-transmitting manner; and an inductive transmitter which has an energisable primary winding and a secondary winding which is spaced apart therefrom and can be electrically conductively coupled to a winding of the rotor. The contactless energy transmission device has rectifier electronics connected to the secondary winding The rectifier electronics are located inside the hollow shaft and are connected thereto for conjoint rotation therewith.

The present invention relates to a contactless energy transmission device for a rotor of an electric machine, in particular a separately excited synchronous machine inside a drive train of a motor vehicle, comprising a hollow shaft which can be coupled to the rotor of the electric machine in a torque-transmitting manner, and an inductive transmitter which has an energizable primary winding and a secondary winding which is spaced apart therefrom and can be electrically conductively coupled to a winding of the rotor, and the contactless energy transmission device has rectifier electronics connected with the secondary winding. The invention further relates to a kit-of-parts for manufacturing a contactless energy transmission device, a rotor of an electric machine and an electric machine.

Electric machines are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which includes an electric motor. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

When developing the electric machines intended for e-axles or hybrid modules, there is a continuing need to increase their power density and efficiency while reducing manufacturing costs, since the cost and weight of the vehicle will be largely determined by the battery size. In this context, it is also known to design the electric machines as separately excited synchronous machines (SESM). In this case, the electrical output for exciting the rotor windings must be transmitted to the rotor of a separately excited synchronous machine. For traction machines, a contact-based transmitter is usually used for this purpose. When these windings are energized, a magnetic field is created which, in combination with the magnetic field of the stator, generates a torque. The strength of the rotor field can be adjusted by the strength of the current supply. In this way, the machine behavior can always be adapted to the respective driving situation in the most efficient way possible.

The disadvantages of such a contact-based transmitter are mechanical and electrical losses in the contact between stationary and rotating components. Further disadvantages are the wear of the components rubbing against each other, the resulting contamination caused by abrasion and the comparatively large installation space requirement.

As an alternative to such contact-based transmitters, contactless, inductive transmitters are also known, for example. An inductive transmitter is usually a rotationally symmetrical transmitter with an air gap consisting of a primary and a secondary winding. As a rule, an inductive transmitter also has a core made of ferrite, for example. Such a core can be made of one or more parts.

For example, all parts of the core can be attached to the stationary machine side of an electric machine, wherein the secondary side winding rotates inside the core. Alternatively, core parts can be attached to the rotating part of the machine. In this case, the primary and secondary core parts are separated by an air gap. This must be large enough to ensure that the core parts do not touch each other, taking into account all tolerances and operating conditions. For this purpose, the rotating transmitter parts are often banded for this purpose or joined to another component to provide support that can withstand the speed of rotation. An example of such a design variant can be found in DE 10 2017 214 776 A1 or in DE 201210201826 A1.

The object of the invention is now to provide a contactless energy transmission device for a rotor of an electric machine, in particular a separately excited synchronous machine inside a drive train of a motor vehicle, which has a compact design and a high level of operational reliability even when high electrical powers are to be transmitted.

This object is achieved by a contactless energy transmission device for a rotor of an electric machine, in particular a separately excited synchronous machine inside a drive train of a motor vehicle, comprising a hollow shaft which can be coupled to the rotor of the electric machine in a torque-transmitting manner, and an inductive transmitter which has an energizable primary winding and a secondary winding which is spaced apart therefrom and can be electrically conductively coupled to a winding of the rotor, and

the contactless energy transmission device has rectifier electronics connected with the secondary winding, wherein the rectifier electronics are arranged inside the hollow shaft and are connected thereto for conjoint rotation therewith.

This has the advantage that the contactless energy transmission device can be designed to be particularly compact by using the installation space of the hollow shaft for the rectifier electronics.

Advantageous embodiments of the invention are specified in the dependent claims. The features listed individually in the dependent claims can be combined with one another in a technologically meaningful manner and can define further embodiments of the invention. In addition, the features indicated in the claims are specified and explained in more detail in the description, wherein further preferred embodiments of the invention are shown.

If the hollow shaft is made of an electrically conductive material, e.g. steel, according to an equally preferable embodiment of the invention, it shields the inductive transmitter from surrounding components and systems and thus contributes to electromagnetic compatibility (EMC) with respect to surrounding components and systems.

The hollow shaft can be formed integrally or in several parts. If the hollow shaft is made up of several parts, these hollow shaft parts can only be joined together after the inductive transmitter has been integrated.

The inductive transmitter can be integrated at any axial position inside the hollow shaft. For example, in the area of a laminated rotor core or in the area of the rotor winding heads.

According to the invention, it is provided that the secondary winding of the inductive transmitter is arranged inside the hollow shaft. It is highly preferable that the secondary coil is positioned axially completely in the hollow shaft. In principle, however, it would also be conceivable that the secondary coil only engages axially in sections of the hollow shaft.

First, the individual elements of the claimed subject matter of the invention are explained in the order of their relevance or their mention in the claims, and then particularly preferred embodiments of the subject matter of the invention are described.

A rotor is the spinning (rotating) part of an electric machine. The rotor comprises in particular a rotor shaft. The rotor shaft can be hollow, which on the one hand results in weight savings and on the other hand allows the supply of lubricant or coolant to the rotor body. Preferably, the hollow shaft of the contactless energy transmission device is a rotor shaft of a rotor of an electric machine that is hollow at least in sections.

The electric machine can in particular be designed as a rotary machine. The rotary machine can in particular be configured as a radial flux machine. A radial flux machine is characterized by the fact that the magnetic field lines in the air gap formed between the rotor and stator extend in a radial direction. The gap between the rotor and the stator is referred to as the air gap. In a radial flux machine, this is a gap with a circular cross-section and a radial width that corresponds to the distance between the rotor body and the stator body.

The electric machine is intended in particular for use inside a drive train of a hybrid or fully electrically driven motor vehicle. In particular, the electric machine is dimensioned such that vehicle speeds of more than 50 km/h, preferably more than 80 km/h, and in particular more than 100 km/h can be achieved. The electric motor particularly preferably has an output of more than 50 kW, preferably more than 80 KW, and in particular more than 150 KW. Furthermore, it is preferred that the electric machine provides speeds greater than 8000 rpm, particularly preferably greater than 12,000 rpm, very particularly preferably greater than 1500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

The inductive transmitter can be arranged inside a hollow shaft. The hollow shaft can be formed integrally or in several parts. It is fundamentally conceivable that the hollow shaft is penetrated completely or only in sections by an opening running in the longitudinal extension of the hollow shaft. For example, it would also be conceivable for the hollow shaft to have a blind hole, into which the inductive transmitter can then be inserted. The hollow shaft is preferably made of a metallic material, in particular steel.

The inductive transmitter is configured such that electrical output, preferably greater than 1 KW and particularly preferably greater than 2 KW, can be transmitted at least briefly without electrically or thermally overloading the transmitter. Most preferably, the inductive transmitter is configured to transmit electrical output between 0.5 kW-10 kW, preferably between 1 kW-5 KW, particularly preferably between 2 kW-4 KW.

The windings of the transmitter are made of an electrically conductive but non-ferromagnetic material, such as copper or aluminum, and are electrically insulated from each other. Preferably, the windings are aligned tangentially around the hollow shaft, resulting in a cylindrical ring-shaped winding body with a diameter and a longitudinal extension in the axial direction. Most preferably, the windings are wound around and/or in a core made of a ferromagnetic material.

The windings can be formed from one or more electrical conductors with a circular cross-section. It is also conceivable that the electrical conductors forming the winding have a cross-sectional shape that deviates from the circular shape, in particular a rectangular shape. Particularly preferably, the windings can be formed from insulated copper foils that can be wound around each other in a similar way to a toilet paper roll.

According to an advantageous further development of the invention, the primary winding can have a higher number of windings than the secondary winding. This means that, when the electrical energy is transferred between the primary winding and the secondary winding, a voltage conversion from the comparatively high battery voltage to the lower rotor voltage can be realized.

In this context, it is further preferred that an electrical voltage of 40-1500V, preferably 100-1000V, most preferably 300-850V is applied to the primary winding. Furthermore, it is preferable in this context that a voltage of 70-500 V is applied to the secondary winding.

The primary core and/or the secondary core are/is made of a ferromagnetic material, preferably a ferrite material. The primary core and/or secondary core can be designed in several parts. The respective core parts are preferably substantially rotationally symmetrical, but can contain elements and recesses for fixing or feeding through additional components.

Particularly preferably, the primary core and/or the secondary core each have a ring-shaped spatial form. Most preferably, the primary core and/or the secondary core have a U-shaped cross-sectional contour with a circumferential groove. Preferably, the grooves of the U-shaped cross-sectional contours of the primary core and secondary core are directed towards each other. It is also particularly preferred that the primary winding goes into the slot of the primary core and/or the secondary winding goes into the slot of the secondary core.

Preferably, the cylindrical ring-shaped secondary winding has a radial outer diameter of less than 500 mm, preferably less than 400 mm, particularly preferably less than 350 mm. Most preferably, the radial outer diameter of the cylindrical ring-shaped secondary winding is selected to be between 100-500 mm, preferably 150-400 mm, most preferably 200-350 mm. This allows the centrifugal forces acting during operation to be limited to an advantageous size.

The axial length of the cylindrical ring-shaped secondary winding is preferably greater than 50%, preferably greater than 70% of the radial outer diameter, in particular of the diameter of the secondary winding. Such an “elongated” design of the winding has proven to be particularly advantageous for energy transmission of the inductive transmitter. In simple terms, flat and elongated designs of the cylindrical ring-shaped secondary windings have proven to be particularly favorable with regard to the energy transfer properties of the inductive transmitter.

It is further highly preferable that the axial length of the cylindrical ring-shaped primary winding is between 80-120% of the axial length of the cylindrical ring-shaped secondary winding, which can also contribute to a good energy transfer between the windings.

Furthermore, it is advantageous that the two axial lengths of the cylindrical ring-shaped windings completely overlap axially, whereby the energy transfer between the primary winding and the secondary winding can be further optimized.

Furthermore, it can be advantageous for the primary core and secondary core to each form surfaces bordering the air gap, via which the magnetic flux is guided from one part to the other. It is advantageous if the surfaces of the primary core bordering the air gap completely cover the surfaces of the secondary core bordering the air gap and/or if the surfaces of the secondary core bordering the air gap completely cover the surfaces of the primary core bordering the air gap, wherein the energy transfer between the primary winding and the secondary winding can be further optimized.

Rectifier electronics can preferably be connected between the secondary winding and a winding of the rotor, such that the secondary winding energizes the winding of the rotor with the rectifier electronics interconnected.

The primary winding can be rotatably mounted and centered relative to the secondary winding, preferably by means of one or more rolling bearings. For this purpose, rolling elements are arranged so as to roll between an inner ring and an outer ring of the rolling bearing.

The inner ring can be made of a metallic and/or ceramic material. In principle, it is conceivable to design the inner ring in one part or in multiple parts, in particular in two parts. The inner ring can have an inner ring groove. In particular, a cover washer, sealing washer and/or seal can be arranged in an inner ring groove, in particular in a force-fitting and/or form-fitting manner. Preferably, the inner ring groove is formed as a circumferential groove in the inner ring.

The outer ring can be made of a metallic and/or ceramic material. In principle, it is conceivable to form the outer ring in one part or in multiple parts, in particular in two parts. The outer ring can have an outer ring groove. In particular, a cover washer, sealing washer and/or seal can be arranged in an outer ring groove, in particular in a force-fitting and/or form-fitting manner. Preferably, the outer ring groove is formed as a circumferential groove in the outer ring.

Depending on the type of rolling bearing, the rolling elements have the shape of a sphere or a cylinder. Roller-shaped elements are also referred to as roller bearing elements and spherical rolling elements as bearing balls. Roller-like rolling elements can be selected, for example, from the group of symmetrical spherical rollers, asymmetrical spherical rollers, cylindrical rollers, needle rollers and/or tapered rollers.

The rolling elements can roll inside the rolling bearing, in particular on the inner ring raceway of the inner ring. For this purpose, the surface of the inner ring raceway can advantageously be designed to be correspondingly abrasion-resistant, for example by means of a corresponding surface treatment method and/or by applying a corresponding additional layer of material. The inner ring raceway can be designed to be planar or profiled. A profiled design of the inner ring raceway can be used, for example, to guide the rolling elements on the inner ring raceway. On the other hand, a planar formation of the inner ring raceway can, for example, allow a certain axial displaceability of the rolling elements on the inner ring raceway.

The rolling elements can roll inside the rolling bearing, in particular on the outer ring raceway of the outer ring. For this purpose, the surface of the outer ring raceway can advantageously be designed to be correspondingly abrasion-resistant, for example by means of a corresponding surface treatment method and/or by applying a corresponding additional layer of material.

The outer ring raceway can be designed to be planar or profiled. A profiled design of the outer ring raceway can be used, for example, to guide the rolling elements on the outer ring raceway. On the other hand, a planar formation of the outer ring raceway can, for example, allow a certain axial displaceability of the rolling elements on the outer ring raceway.

Rolling elements can be guided and spaced apart in a cage or by rolling element spacers. In principle, it is also conceivable to design a rolling bearing without a cage, which is also referred to as a full-complement rolling bearing. In full-complement rolling bearings, adjacent rolling elements can contact one another.

A rolling bearing can have a cage, wherein the cage guides the rolling elements. The cage is designed such that the rolling element balls and/or the rolling element rollers are spaced apart from one another so that, for example, the friction and heat development of the rolling elements is kept as low as possible. Furthermore, the cage keeps the rolling element balls and/or rolling element rollers at a fixed distance from one another during rolling, as a result of which an even load distribution can be achieved. The cage can be made in one piece or in multiple pieces.

A rolling bearing can have a seal in order to prevent the escape of lubricant from the rolling bearing or the ingress of dirt or moisture into the rolling bearing. For this purpose, the seals used can be provided with one or more seal lips, which can bear against a component of the rolling bearing. These are designed such that, on the one hand, they seal the bearing as long as possible over its entire service life, and on the other hand, the level of friction caused by the contiguous seal is not too high.

The invention further comprises a method for assembling a rotor of an electric machine, in particular a separately excited synchronous machine inside a drive train of a motor vehicle, comprising the following steps:
Provision of an inductive transmitter which has an energizable primary winding and a secondary winding which is spaced apart therefrom and can be electrically conductively coupled to a winding of the rotor, and
Provision of a hollow shaft which can be coupled to the rotor of the electric machine in a torque-transmitting manner, and
Insertion of the inductive transmitter into the hollow shaft.

Furthermore, according to an equally advantageous embodiment of the invention, it can be provided that the rolling bearing has an inner ring and an outer ring, between which a plurality of rolling elements are accommodated, wherein the inner ring is connected to the hollow shaft for conjoint rotation and the outer ring is connected to the lance for conjoint rotation. This can particularly support a modular configuration of the rolling bearing and the hollow shaft. For this purpose, it is then further advantageous that the lance has a first cylinder ring section, on the outer lateral surface of which the primary winding is arranged, and the lance also has a second cylinder ring section arranged coaxially to the first cylinder ring section, on the inner lateral surface of which the outer ring of the rolling bearing is arranged, wherein the first cylinder ring section has a smaller diameter than the second cylinder ring section. Furthermore, the invention can also be further developed such that the rolling bearing, the hollow shaft, the lance and the inductive transmitter form a modular structural unit.

Preferably, a method for assembling a rotor of an electric machine, in particular a separately excited synchronous machine inside a drive train of a motor vehicle, can comprise the following steps:
Provision of a rotor shaft,
Provision of a contactless energy transmission device
Connection of the hollow shaft of the contactless energy transmission device to the rotor shaft,
Coupling of the secondary winding with a winding of the rotor

The contactless energy transmission device can have rectifier electronics connected with the secondary winding.

In an equally preferable embodiment variant of the invention, it can also be provided that the contactless energy transmission device has rectifier electronics, which are also arranged inside the hollow shaft and are connected thereto for conjoint rotation therewith.

According to a further preferred further development of the invention, it can also be provided that the rectifier electronics have a circuit board with electronic components arranged thereon, wherein the circuit board has a substantially disc-shaped or circular disc-shaped or cylindrical ring-shaped contour.

In principle, it is also conceivable that the circuit board is not completely closed or is made up of several segments. It may therefore also be preferable for the circuit board to have a contour in the shape of a disc section, a circular disc section or a cylindrical ring section.

Furthermore, according to an equally advantageous embodiment of the invention, it can be provided that the circuit board is connected to the hollow shaft in a materially-bonded, force-fitting and/or form-fitting manner for conjoint rotation. Alternatively, it would also be possible that the rectifier electronics are accommodated in a housing that has a contour substantially in the shape of a disc, disc section or circular disc, circular disc section, cylindrical ring or cylindrical ring section and the housing is connected to the hollow shaft in a materially-bonded, force-fitting and/or form-fitting manner for conjoint rotation. The housing can provide additional mechanical, chemical or electromagnetic protection for the rectifier electronics. The housing can, for example, be made of a plastic or a metallic material. The housing can be designed as a single part or multiple parts.

The rectifier electronics can also be encapsulated in an electrically non-conductive material.

Furthermore, the invention can also be further developed in such a way that a cooling fluid can flow through the hollow shaft such that heat generated by the rectifier electronics can be dissipated by means of the cooling fluid when the contactless energy transmission device is in operation, which favors particularly low-loss operation of the inductive transmitter.

The invention can also be embodied as a kit-of-parts for manufacturing a contactless energy transmission device for a rotor of an electric machine, in particular a separately excited synchronous machine inside a drive train of a motor vehicle. The kit-of-parts then includes in particular:
an inductive transmitter which has an energizable primary winding and a secondary winding which is spaced apart therefrom and can be electrically conductively coupled to a winding of the rotor,
a hollow shaft which can be coupled to the rotor of the electric machine in a torque-transmitting manner,
rectifier electronics which can be connected to the secondary winding, which can be positioned inside the hollow shaft and can be connected thereto for conjoint rotation therewith.

This allows the components necessary for manufacturing the energy transmission device to be made available in a particularly convenient manner. The kit-of-parts can, for example, be a packaging unit. Furthermore, it is possible to design the kit-of-parts as a compilation of separate storage containers for storing the individual components or the respective component groups of the kit-of-parts.

The invention can also comprise a method for assembling a rotor of an electric machine, in particular a separately excited synchronous machine inside a drive train of a motor vehicle. Such an assembly process then comprises, for example, the following steps:
Provision of a hollow shaft which can be coupled to the rotor of the electric machine in a torque-transmitting manner, and
Provision of an inductive transmitter which has an energizable primary winding and a secondary winding which is spaced apart therefrom and can be electrically conductively coupled to a winding of the rotor, and
Provision of rectifier electronics which can be coupled to the secondary winding,
Insertion of the rectifier electronics into the hollow shaft so that the rectifier electronics are connected to the hollow shaft for conjoint rotation,
Connection of the rectifier electronics to the secondary winding of the inductive transmitter.

According to an advantageous embodiment of the invention, it can be provided that the primary winding and the secondary winding of the inductive transmitter are arranged coaxially to one another inside the hollow shaft. The advantage of this embodiment is that it enables particularly efficient electrical energy transmission.

According to a further preferred further development of the invention, it can also be provided that the primary winding is arranged on a lance extending axially into the interior of the hollow shaft. The lance can in particular be designed as a hollow cylindrical shaft.

Furthermore, according to an equally advantageous embodiment of the invention, it can be provided that the lance has at least one cooling channel, through which a cooling fluid can flow. The advantageous effect of this embodiment is based on the fact that it enables particularly good cooling of the primary winding.

According to a further particularly preferred embodiment of the invention, it can be provided that the contactless energy transmission device has rectifier electronics, which are also arranged inside the hollow shaft and are connected thereto for conjoint rotation therewith. In principle, the electronics for rectification can be placed anywhere in or on the rotor. However, it is preferred that the electronics for rectification are also positioned inside the hollow shaft, since the conditions here are also more favorable for these in terms of speed stability and thermal conditions.

Furthermore, the invention can also be further developed in such a way that the lance is mounted opposite the hollow shaft by means of a rolling bearing located in the hollow shaft. The advantage of this embodiment is that it allows a particularly tolerant and thus small annular gap to be formed between the primary coil and the secondary coil.

The object of the invention is further achieved by a kit-of-parts for manufacturing a contactless energy transmission device for a rotor of an electric machine, in particular a separately excited synchronous machine inside a drive train of a motor vehicle, comprising an inductive transmitter which has an energizable primary winding and a secondary winding which is spaced apart therefrom, which can be electrically conductively coupled to a winding of the rotor, a hollow shaft which can be coupled to the rotor of the electric machine in a torque-transmitting manner, and the secondary winding of the inductive transmitter is arranged inside the hollow shaft and connected thereto for conjoint rotation therewith, and a lance that can be inserted axially into the interior of the hollow shaft, on which the primary winding of the inductive transmitter is arranged.

The resulting advantage is in particular that the components of the contactless energy transmission device to be assembled can be provided in a particularly convenient manner. The kit-of-parts can, for example, be a packaging unit. Furthermore, it is possible to design the kit-of-parts as a compilation of separate storage containers for storing the individual components or the respective component groups of the kit-of-parts.

According to a further preferred embodiment of the subject matter of the invention, a rotor of an electric machine, in particular a separately excited synchronous machine inside a drive train of a motor vehicle, comprising a contactless energy transmission device according to one of claims 1-7, can be provided.

Finally, the object of the invention can also be achieved by an electric machine, in particular a separately excited synchronous machine inside a drive train of a motor vehicle, comprising a rotor according to claim 8.

According to a further preferred further development of the invention, it can also be provided that the rectifier electronics have a circuit board with electronic components arranged thereon, wherein the circuit board has a substantially disc-shaped, disc section-shaped or circular disc-shaped, circular disc section-shaped or cylindrical ring-shaped, cylindrical ring section-shaped contour. Furthermore, according to an equally advantageous embodiment of the invention, it can be provided that the circuit board is connected to the hollow shaft in a materially-bonded, force-fitting and/or form-fitting manner for conjoint rotation. According to a further particularly preferred embodiment of the invention, it can be provided that the rectifier electronics are accommodated in a housing that has a contour substantially in the shape of a disc, disc section or circular disc, circular disc section, cylindrical ring or cylindrical ring section and the housing is connected to the hollow shaft in a materially-bonded, force-fitting and/or form-fitting manner for conjoint rotation. Furthermore, the invention can also be further developed in such a way that a cooling fluid can flow through the hollow shaft such that heat generated by the rectifier electronics can be dissipated by means of the cooling fluid when the contactless energy transmission device is in operation.

The object of the invention can also be achieved by a rotor of an electric machine, in particular a separately excited synchronous machine inside a drive train of a motor vehicle, comprising a contactless energy transmission device according to one of claims 1-6.

The object of the invention can further be achieved by an electric machine, in particular a separately excited synchronous machine inside a drive train of a motor vehicle, comprising a rotor according to claim 7.

Finally, the object of the invention can also be achieved by a method for assembling rotor of an electric machine, in particular a separately excited synchronous machine inside a drive train of a motor vehicle, comprising the following steps:
Provision of a hollow shaft which can be coupled to the rotor of the electric machine in a torque-transmitting manner, and
Provision of an inductive transmitter which has an energizable primary winding and a secondary winding which is spaced apart therefrom and can be electrically conductively coupled to a winding of the rotor, and
Provision of rectifier electronics which can be coupled to the secondary winding,
Insertion of the rectifier electronics into the hollow shaft so that the rectifier electronics are connected to the hollow shaft for conjoint rotation,
Connection of the rectifier electronics to the secondary winding of the inductive transmitter.

The invention is explained in more detail below with reference to figures without limiting the general concept of the invention.

In the drawings:

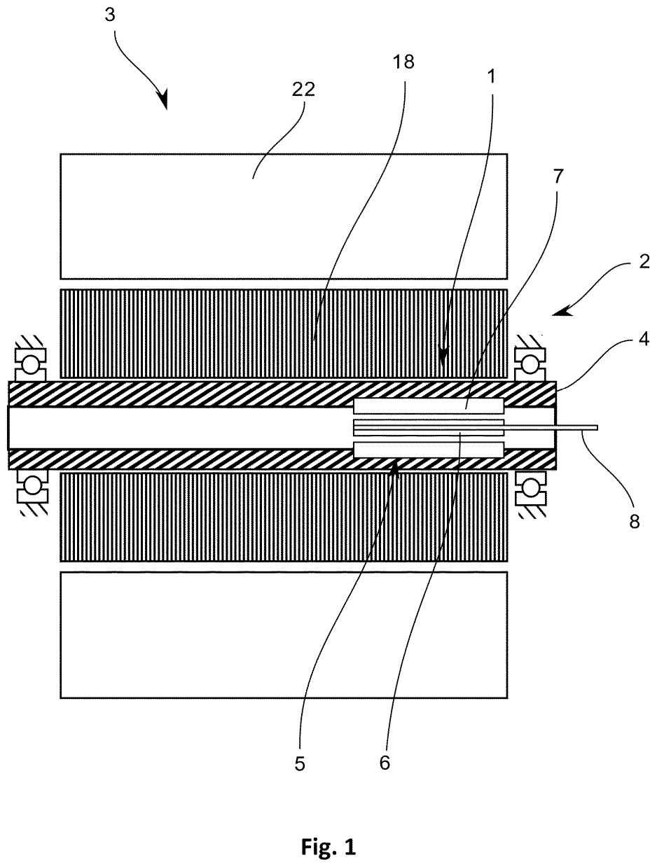

FIG. 1 shows an electric machine with a contactless energy transmission device in a schematic axial sectional view,

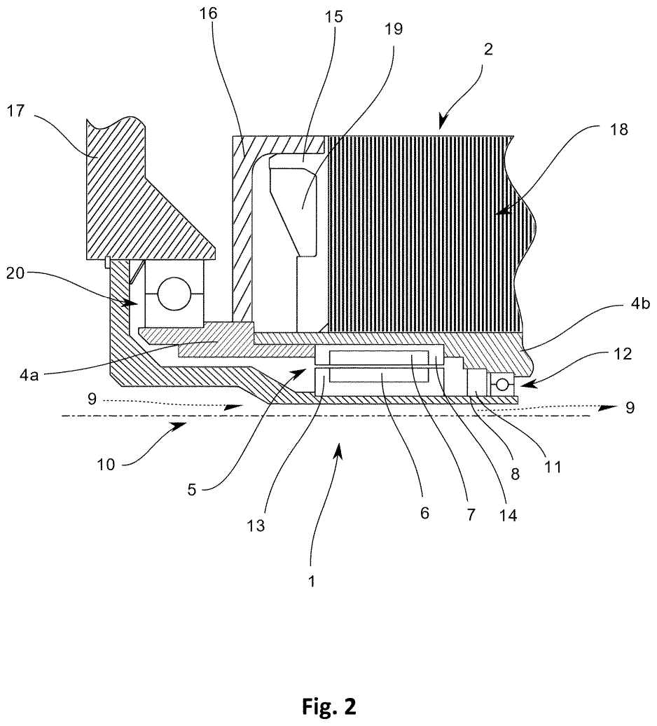

FIG. 2 shows a detailed view of the contactless energy transmission device in an axial sectional view,

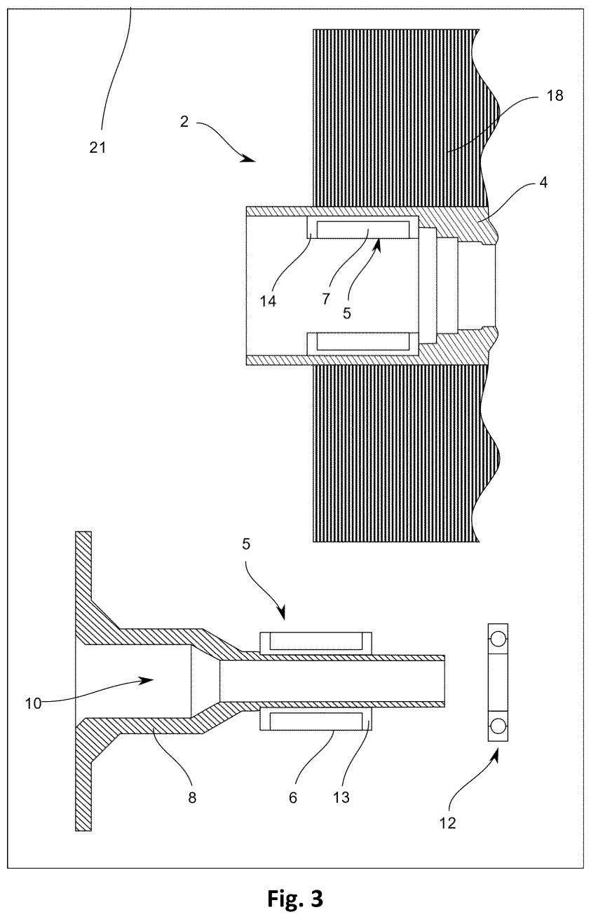

FIG. 3 shows a kit-of-parts for manufacturing a contactless energy transmission device for a rotor of an electric machine,

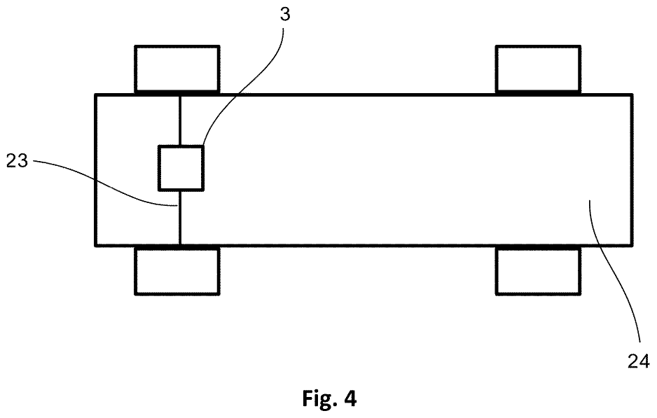

FIG. 4 shows a motor vehicle with an electric machine in a block diagram,

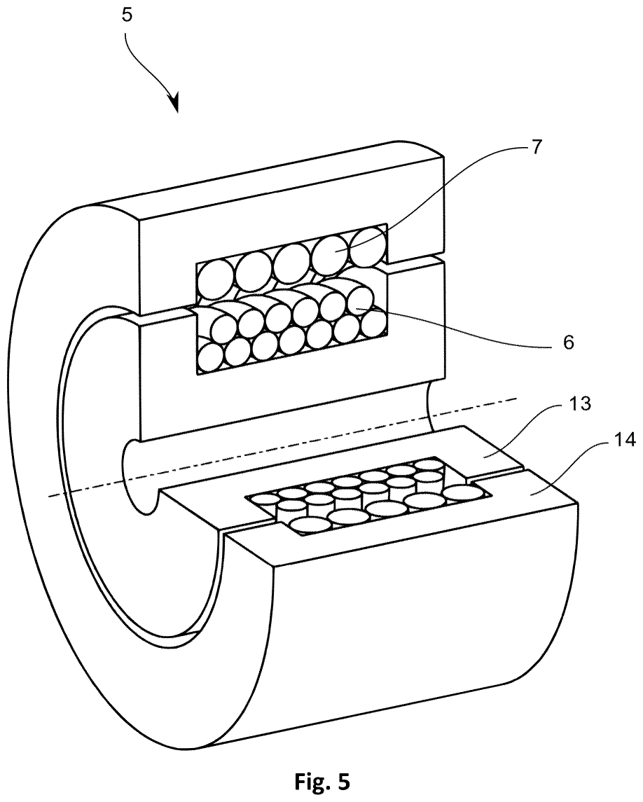

FIG. 5 shows an inductive transmitter in a perspective partial sectional view,

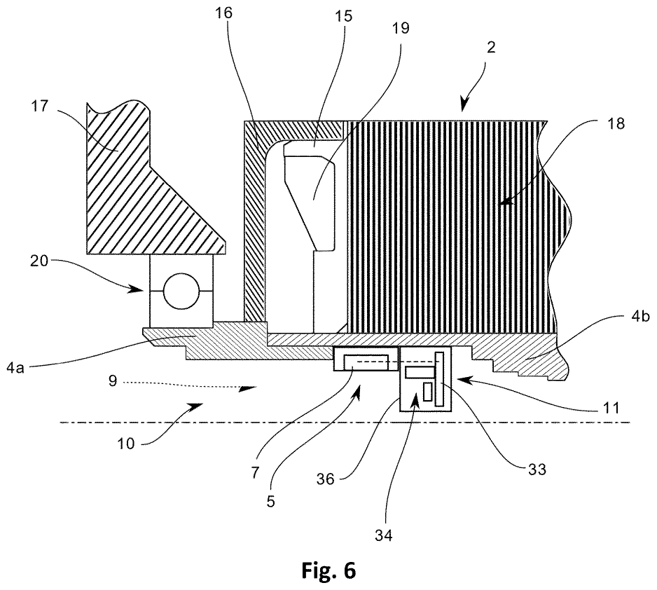

FIG. 6 shows a first embodiment of an arrangement of rectifier electronics in a hollow shaft in an axial sectional view,

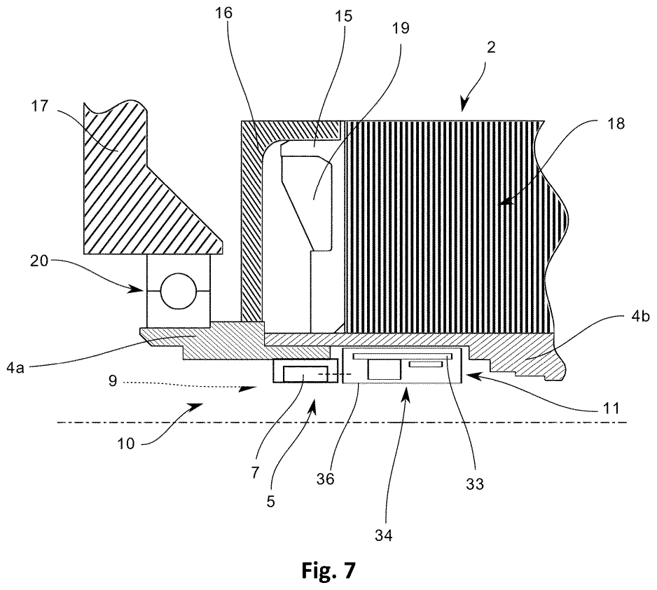

FIG. 7 shows a second embodiment of an arrangement of rectifier electronics in a hollow shaft in an axial sectional view,

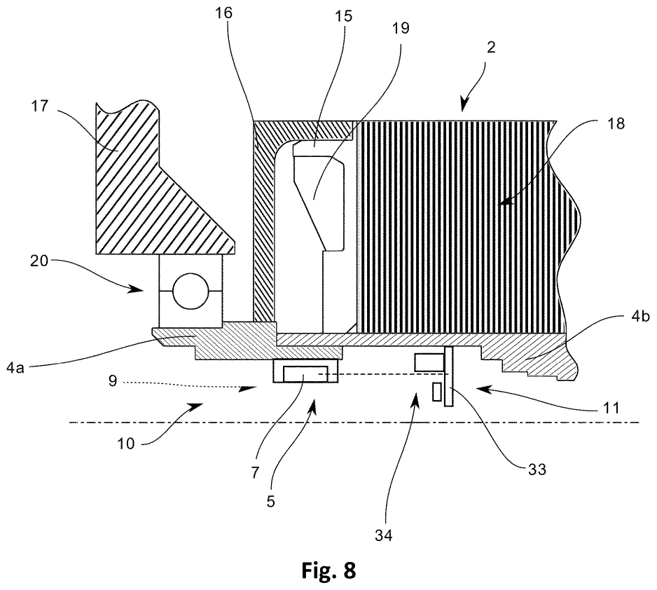

FIG. 8 shows a third embodiment of an arrangement of rectifier electronics in a hollow shaft in an axial sectional view,

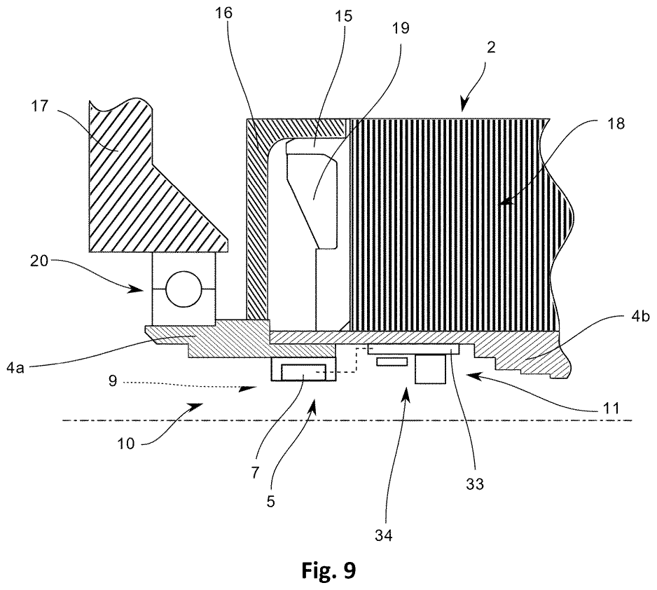

FIG. 9 shows a fourth embodiment of an arrangement of rectifier electronics in a hollow shaft in an axial sectional view,

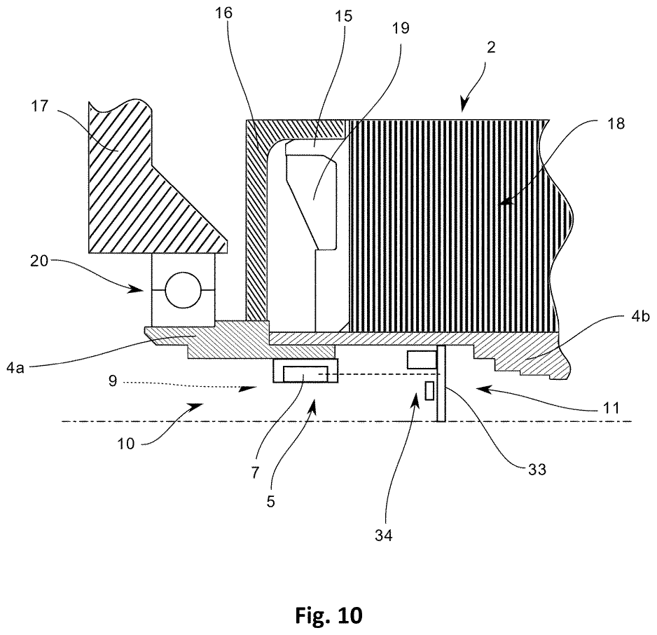

FIG. 10 shows a fifth embodiment of an arrangement of rectifier electronics in a hollow shaft in an axial sectional view,

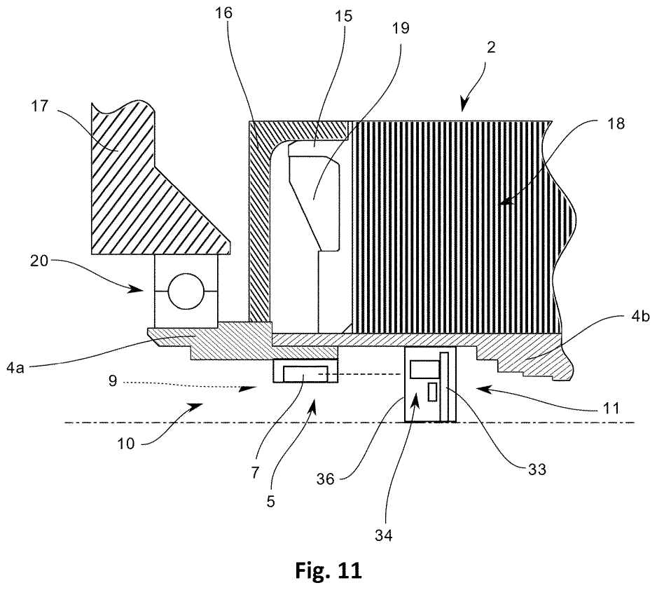

FIG. 11 shows a sixth embodiment of an arrangement of rectifier electronics in a hollow shaft in an axial sectional view,

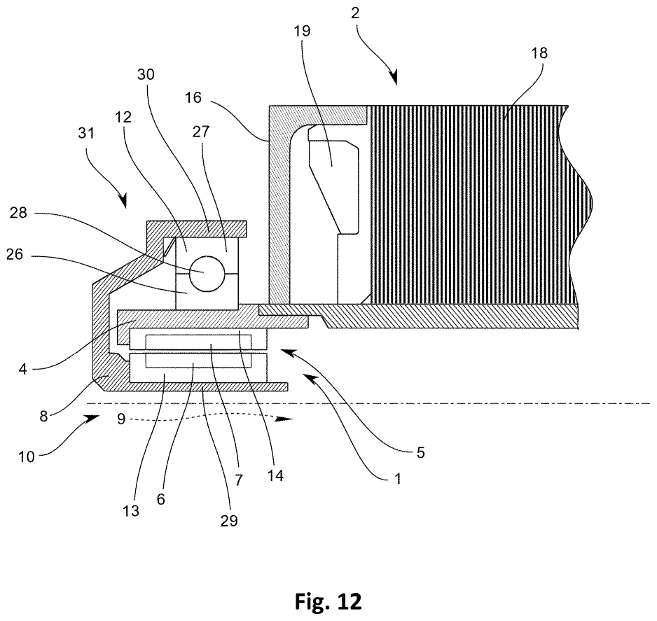

FIG. 12 shows a detailed view of a contactless energy transmission device inside a rolling bearing in an axial sectional view,

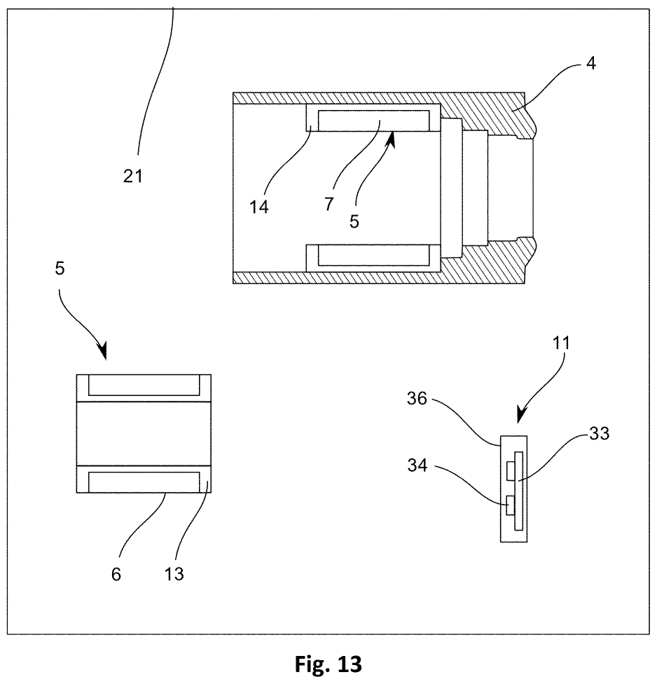

FIG. 13 shows a kit-of-parts for manufacturing a contactless energy transmission device for a rotor of an electric machine.

FIG. 1 shows a contactless energy transmission device 1 for a rotor 2 of an electric machine 3. In the embodiment shown in FIG. 1, the electric machine 3 is configured as a separately excited synchronous machine for a drive train 23 of a motor vehicle 24, as is also outlined by way of example in FIG. 4.

The rotor 2, which is rotatably mounted in the cylindrical ring-shaped stator 22, has a hollow shaft 4 which is connected to the rotor 2 of the electric machine 3 in a torque-transmitting manner. The rotor 2 also comprises a laminated rotor stack 18 which is connected to the hollow shaft 4 for conjoint rotation. The hollow shaft 4 thus forms the rotor shaft of the rotor 2.

An inductive transmitter 5 is provided to energize the rotor 2, which inductive transmitter 5 has an energizable primary winding 6 and a secondary winding 7 spaced apart therefrom, which is electrically conductively coupled to a winding of the rotor 2.

As can be clearly seen from FIG. 1, the secondary winding 7 of the inductive transmitter 5 is arranged inside the hollow shaft 4 and is connected thereto for conjoint rotation therewith, while the primary winding 6 of the inductive transmitter 5 is positioned therein in a torsionally rigid manner relative to the hollow shaft 4, such that the secondary winding 7 rotates around the primary winding 6. The primary winding 6 and the secondary winding 7 of the inductive transmitter 5 are arranged coaxially to one another inside the hollow shaft 4. The primary winding 6 is arranged on a lance 8 extending axially into the interior of the hollow shaft 4.

From FIG. 2, it can be clearly seen that the lance 8 can be designed in the shape of a cylindrical ring and then has an axially extending cooling channel 10, through which a cooling fluid 9 can flow. This ensures that the heat generated at the primary winding 6 can be efficiently dissipated. In the embodiment of the hollow shaft 4 shown in FIG. 2, this is designed in two parts and consists of a first hollow cylindrical shaft section 4a and a second hollow cylindrical shaft section 4b, which are connected to each other for conjoint rotation.

In the embodiment shown in FIG. 2, the contactless energy transmission device 1 also has rectifier electronics 11, which can also be arranged inside the hollow shaft 4 and connected thereto for conjoint rotation therewith. In principle, it would also be conceivable to provide a seal between the hollow shaft 4 and the lance 8 in order to protect the inductive transmitter 5 from the ingress of dirt and/or cooling fluid, which, however, is not shown in the figures.

The laminated rotor core 18 of the rotor 2 is connected to the radially outer lateral surface of the hollow shaft 4 for conjoint rotation. From this, the rotor winding head 19 extends in the axial direction from the distal end face of the laminated rotor core 18.

FIG. 2 further shows that the hollow cylindrical lance 8 can be mounted relative to the hollow shaft 4 by means of a rolling bearing 12 arranged in the hollow shaft 4.

In FIG. 3, a kit-of-parts 21 for manufacturing a contactless energy transmission device 1 for a rotor 2 of an electric machine 3, in particular a separately excited synchronous machine inside a drive train of a motor vehicle, is shown. For example, the kit-of-parts 21 can be used for converting or equipping an electric machine 3 from a contact-based power supply of a rotor 2 to a contactless power supply and provides the corresponding equipment components for this purpose.

The kit-of-parts 21 comprises an inductive transmitter 5 which has an energizable primary winding 6 and a secondary winding 7 which is spaced apart therefrom and can be electrically conductively coupled to a winding of the rotor 2, and a hollow shaft 4 which can be coupled to the rotor 2 of the electric machine 3 in a torque-transmitting manner. In doing so, the secondary winding 7 of the inductive transmitter 5 is arranged inside the hollow shaft 4 and connected thereto for conjoint rotation therewith. The kit-of-parts 21 further comprises a lance 8 that can be inserted axially into the interior of the hollow shaft 4, on which the primary winding 6 of the inductive transmitter 5 is arranged. This means that, for example, an existing hollow shaft can be exchanged and replaced by the hollow shaft of the kit-of-parts 21. Subsequently, the cylindrical ring-shaped lance 8 can then be inserted into the hollow shaft 4, wherein the primary winding 6 and the secondary winding 7 are then aligned coaxially with each other, as is also shown in the assembled state of the lance 8 in FIG. 2. The rolling bearing 12 in the kit-of-parts 21 is provided as an option for storing the cylindrical ring-shaped lance 8.

FIG. 5 shows a detailed view of the inductive transmitter 5. The primary core 13 and the secondary core 14, each of which has a ring-shaped spatial form, can be seen. Both the primary core 13 and the secondary core 14 have a U-shaped cross-sectional contour with a circumferential groove, wherein the grooves of the U-shaped cross-sectional contours of the primary core 13 and the secondary core 14 are directed towards each other.

The primary winding 6 goes into the slot of the primary core 13 and the secondary winding 7 into the slot of the secondary core 14. The primary core 13 and the secondary core 14 are made of a ferromagnetic material, preferably a ferrite material.

In the embodiment shown in FIG. 5, the primary winding 6 has a higher number of windings than the secondary winding 7, so that, when the electrical energy is transferred between the primary winding 6 and the secondary winding 7, a voltage conversion from the comparatively high battery voltage to the lower rotor voltage can be realized at the same time.

The two axial lengths of the cylindrical ring-shaped windings 6,7 overlap almost completely axially, which allows for an optimal and preferably loss-free energy transfer between the primary winding 6 and the secondary winding 7.

FIGS. 6-11 show various possibilities for arranging the rectifier electronics 11 inside the hollow shaft 4.

In all embodiments of FIGS. 6-11, the contactless energy transmission device 1 is connected to the secondary winding 7 with rectifier electronics 11. The rectifier electronics 11 are each arranged inside the hollow shaft 4 and are connected thereto for conjoint rotation therewith.

As shown in FIGS. 6-11, the secondary winding 7 of the inductive transmitter 5 is preferably arranged inside the hollow shaft 4 and is connected thereto for conjoint rotation therewith, while the primary winding 6 of the inductive transmitter 5 is positioned therein in a torsionally rigid manner relative to the hollow shaft 4, which, however, is not shown in FIGS. 6-11 for reasons of clarity.

The rectifier electronics 11 have a circuit board 33 with electronic components 34 arranged thereon.

In the embodiment of FIG. 10, the circuit board 33 has a substantially disc-shaped or disc section-shaped contour which extends substantially in the radial direction inside the hollow shaft 4. FIG. 8 shows a similar configuration, in which, however, the circuit board 33 has a circular disc-shaped or circular disc section-shaped contour, so that the circuit board 33 can be passed through and/or flowed through in the axial direction.

FIG. 9 shows a further possible arrangement of the circuit board 33, in which the circuit board 33 has a cylindrical ring-shaped or cylindrical ring section-shaped contour and extends substantially in the axial direction inside the hollow shaft 4.

FIGS. 6, 7, 11 show further embodiments of the rectifier electronics 11, in which the rectifier electronics 11 are accommodated in a housing 36, which in turn is connected to the hollow shaft 4 in a materially-bonded, force-fitting and/or form-fitting manner for conjoint rotation. In the embodiment variant of FIG. 11, the housing 36 has a substantially disc-shaped or disc section-shaped contour.

The housing 36 can also have a circular disc-shaped or circular disc section contour, as can also be seen in FIG. 6. As a result, the housing 36 can be passed through, for example, by the lance 8 or by a cooling fluid 9. In the embodiments of FIGS. 6 and 11, the housing extends like an circular disc substantially in the radial direction. In principle, it is also possible for the housing 36 to extend in the axial direction, as shown in FIG. 7. In this embodiment, the housing has a cylindrical ring-shaped or cylindrical ring section-shaped contour.

As can also be seen from FIGS. 6-11, the hollow shaft 4 is designed so that a cooling fluid 9 can flow through it in such a way that heat generated by the rectifier electronics 11 can be dissipated by means of the cooling fluid 9 when the contactless energy transmission device 1 is in operation. For this purpose, the hollow shaft 4 is also used as a cooling channel 10, through which the cooling fluid 9 can be conveyed axially.

FIG. 12 shows an embodiment of the invention, in which the hollow shaft 4 is rotatably mounted relative to a torsionally rigid connection structure 25 by means of a rolling bearing 12. In the embodiment shown, the connection structure 25 is the lance 8. The secondary winding 7 of the inductive transmitter 5 is also arranged inside the hollow shaft 4 here and is connected thereto for conjoint rotation therewith, while the primary winding 6 of the inductive transmitter 5 is positioned therein in a torsionally rigid manner relative to the hollow shaft 4. In the embodiment shown, the primary winding 6 is arranged on a lance 8 extending axially into the interior of the hollow shaft 4.

The rolling bearing 12 has an inner ring 26 and an outer ring 27, between which a plurality of rolling elements 28 are accommodated, wherein the inner ring 26 is connected to the hollow shaft 4 for conjoint rotation and the outer ring 27 is connected to the lance 8 for conjoint rotation.

The lance 8 has a first hollow cylindrical cylinder ring section 29, on the outer lateral surface of which the primary winding 6 is arranged, and the lance 8 also has a second cylinder ring section 30 arranged coaxially to the first cylinder ring section 29, on the inner lateral surface of which the outer ring 27 of the rolling bearing 12 is arranged, wherein the first cylinder ring section 29 has a smaller diameter than the second cylinder ring section 30. The rolling bearing 12, the hollow shaft 4, the lance 8 and the inductive transmitter 5 form a modular structural unit 31.

Even if it is not shown in FIG. 12, the contactless energy transmission device 1 can have rectifier electronics 11, which are also arranged inside the hollow shaft 4 and connected thereto for conjoint rotation therewith.

FIG. 13 shows another possible kit-of-parts 21 for manufacturing a contactless energy transmission device 1 for a rotor 2 of an electric machine 3. It comprises an inductive transmitter 5 which has an energizable primary winding 6 and a secondary winding 7 which is spaced apart therefrom and can be electrically conductively coupled to a winding of the rotor 2, and

a hollow shaft 4 which can be coupled to the rotor 2 of the electric machine 3 in a torque-transmitting manner. Furthermore, the kit-of-parts 21 has rectifier electronics 11 that can be connected to the secondary winding 7, which can be positioned inside the hollow shaft 4 and can be connected thereto for conjoint rotation therewith.

For example, the following method for assembling a rotor 2 of an electric machine 3 can be carried out using the kit-of-parts 21 known from FIG. 13. Firstly, a hollow shaft 4 which can be coupled to the rotor 2 of the electric machine 3 in a torque-transmitting manner is provided and an inductive transmitter 5 which has an energizable primary winding 6 and a secondary winding 7 which is spaced apart therefrom and can be electrically conductively coupled to a winding of the rotor 2 is provided. Rectifier electronics 11 that can be coupled to the secondary winding 7 are also provided.

Then, the rectifier electronics 11 are inserted into the hollow shaft 4 so that the rectifier electronics 11 are connected to the hollow shaft 4 for conjoint rotation. Finally, the rectifier electronics 11 can then be connected to the secondary winding 7 of the inductive transmitter 5.

The invention is not limited to the embodiments shown in the figures. The above description is therefore not to be regarded as limiting, but rather as illustrative. The following claims are to be understood as meaning that a stated feature is present in at least one embodiment of the invention. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Energy transmission device
2 Rotor
3 Electric machine
4 Hollow shaft
5 Transmitter
6 Primary winding
7 Secondary winding
8 Lance
9 Cooling fluid
10 Cooling channel
11 Rectifier electronics
12 Rolling bearing
13 Primary core
14 Secondary core
15 Star cap
16 Rotor cover
17 Housing structure
18 Laminated rotor core
19 Rotor winding head
20 Rolling bearing
21 Kit-of-parts
22 Stator
23 Drive train
24 Motor vehicle
25 Connection structure
26 Inner ring
27 Outer ring
28 Rolling element
29 Cylinder ring section
30 Cylinder ring section
31 Unit
32 Rotor shaft
33 Circuit board
34 Electronic components
35 Contour
36 Housing

1. A contactless energy transmission device for a rotor of an electric machine, including a separately excited synchronous machine inside a drive train of a motor vehicle, comprising:
a hollow shaft coupled to the rotor of the electric machine in a torque-transmitting manner; and
an inductive transmitter having an energizable primary winding and a secondary winding spaced apart therefrom and electrically conductively coupled to a winding of the rotor; and
rectifier electronics connected to the secondary winding,
wherein the rectifier electronics are arranged inside the hollow shaft and are connected thereto for conjoint rotation therewith.

2. The contactless energy transmission device of claim 1, wherein the secondary winding of the inductive transmitter is arranged inside the hollow shaft and is connected thereto for conjoint rotation therewith, while the primary winding of the inductive transmitter is positioned therein in a torsionally rigid manner relative to the hollow shaft.

3. The contactless energy transmission device of claim 1, wherein the rectifier electronics have a circuit board with electronic components arranged thereon, the circuit board has a substantially disc-shaped or circular disc-shaped or cylindrical ring-shaped contour.

4. The contactless energy transmission device of claim 3, wherein the circuit board is connected to the hollow shaft in a materially-bonded, force-fitting and/or form-fitting manner for conjoint rotation.

5. The contactless energy transmission device of claim 1, wherein the rectifier electronics are accommodated in a housing that has a substantially disc-shaped or circular disc-shaped or cylindrical ring-shaped contour and the housing is connected to the hollow shaft in a materially-bonded, force-fitting and/or form-fitting manner for conjoint rotation.

6. The contactless energy transmission device of claim 1, wherein the hollow shaft is designed so that a cooling fluid can flow through it in such a way that heat generated by the rectifier electronics can be dissipated by the cooling fluid when the contactless energy transmission device is in operation.

7. A kit-of-parts for manufacturing a contactless energy transmission device for a rotor of an electric machine, including a separately excited synchronous machine inside a drive train of a motor vehicle, the kit-of-parts comprising:
an inductive transmitter having an energizable primary winding and a secondary winding spaced apart therefrom and is electrically conductively coupled to a winding of the rotor;
a hollow shaft coupled to the rotor of the electric machine in a torque-transmitting manner; and
rectifier electronics connected to the secondary winding and positioned inside the hollow shaft and connected thereto for conjoint rotation therewith.

8. A rotor of an electric machine, including a separately excited synchronous machine inside a drive train of a motor vehicle, comprising a contactless energy transmission device according to claim 1.

9. An electric machine, including a separately excited synchronous machine inside a drive train of a motor vehicle, comprising a rotor according to claim 8.

10. A method for assembling a rotor of an electric machine, including a separately excited synchronous machine inside a drive train of a motor vehicle, the method comprising:
providing a hollow shaft coupled to the rotor of the electric machine in a torque-transmitting manner; and
providing an inductive transmitter having an energizable primary winding and a secondary winding which is spaced apart therefrom and is electrically conductively coupled to a winding of the rotor;
providing rectifier electronics coupled to the secondary winding;
inserting the rectifier electronics into the hollow shaft so that the rectifier electronics are connected to the hollow shaft for conjoint rotation; and
connecting the rectifier electronics to the secondary winding of the inductive transmitter.
